(19) United States
(12) Patent Application Publication
(10) Pub. No.: US 2025/0267228 A1
(43) Pub. Date: Aug. 21, 2025

(54) IMAGE READING DEVICE, IMAGE FORMING APPARATUS, AND IMAGE READING METHOD

(71) Applicant: KYOCERA Document Solutions Inc., Osaka-shi (JP)

(72) Inventor: THANH CONG LE, Osaka (JP)

(21) Appl. No.: 19/023,038

(22) Filed: Jan. 15, 2025

(30) Foreign Application Priority Data
Feb. 15, 2024 (JP) 2024-020834

(51) Int. Cl. H04N 1/00

(52) U.S. Cl. CPC H04N 1/00978; H04N 1/0057; H04N 1/00798; H04N 2201/0081; H04N 2201/0094

(57) ABSTRACT

An image reading device includes: a conveying portion configured to convey a sheet; a reading portion configured to read an image of the sheet; a driving portion configured to drive the conveying portion; and a switch processing portion configured to switch an operation mode of the driving portion alternately between a drive mode for driving the conveying portion and a cool mode for cooling the driving portion. When, in the drive mode, a total driving time of the driving portion exceeds a first threshold, the switch processing portion switches the operation mode to the cool mode.

### INCORPORATION BY REFERENCE

This application is based upon and claims the benefit of priority from the corresponding Japanese Patent Application No. 2024-020834 filed on Feb. 15, 2024, the entire contents of which are incorporated herein by reference.

### BACKGROUND

The present disclosure relates to an image reading device, an image forming apparatus, and an image reading method for reading an image of a conveyed document sheet.

There is known an image reading device including: a conveying portion for conveying a document sheet that is a reading object; and a reading portion for reading an image of the document sheet. In the image reading device, since the temperature of a motor (a driving portion) for driving the conveying portion rises, a function for suppressing temperature rise of the motor is provided.

### SUMMARY

An image reading device according to an aspect of the present disclosure includes: a conveying portion configured to convey a sheet; a reading portion configured to read an image of the sheet; a driving portion configured to drive the conveying portion; and a switch processing portion configured to switch an operation mode of the driving portion alternately between a drive mode for driving the conveying portion and a cool mode for cooling the driving portion. When, in the drive mode, a total driving time of the driving portion exceeds a first threshold, the switch processing portion switches the operation mode to the cool mode.

An image forming apparatus according to another aspect of the present disclosure includes the image reading device and an image forming portion configured to form an image on the sheet.

An image reading method according to a further aspect of the present disclosure includes a switching step of, in an image reading device including: a conveying portion configured to convey a sheet; a reading portion configured to read an image of the sheet; and a driving portion configured to drive the conveying portion, switching an operation mode of the driving portion alternately between a drive mode for driving the conveying portion and a cool mode for cooling the driving portion. In the switching step, when, in the drive mode, a total driving time of the driving portion exceeds a first threshold, the operation mode is switched to the cool mode.

According to the present disclosure, it is possible to provide an image reading device, an image forming apparatus, and an image reading method that can suppress temperature rise of a motor with a simple configuration.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of the present disclosure.

FIG. 2 is a diagram showing a configuration of an ADF and an image reading portion of the image forming apparatus according to the embodiment of the present disclosure.

FIG. 3 is a diagram showing an example of driving state information stored in the image forming apparatus according to the embodiment of the present disclosure.

FIG. 4 is a timing chart showing a change of ON/OFF state of the image forming apparatus and a driving portion according to the embodiment of the present disclosure.

FIG. 5 is a graph showing an experimental result of a temperature change of the driving portion according to the embodiment of the present disclosure.

FIG. 6 is a diagram showing an example of the driving state information stored in the image forming apparatus according to the embodiment of the present disclosure.

FIG. 7 is a diagram showing an example of the driving state information stored in the image forming apparatus according to the embodiment of the present disclosure.

FIG. 8 is a diagram showing an example of the driving state information stored in the image forming apparatus according to the embodiment of the present disclosure.

FIG. 9 is a flowchart showing an example of an operation mode switching process executed by the image forming apparatus according to the embodiment of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

### Configuration of Image Forming Apparatus 100

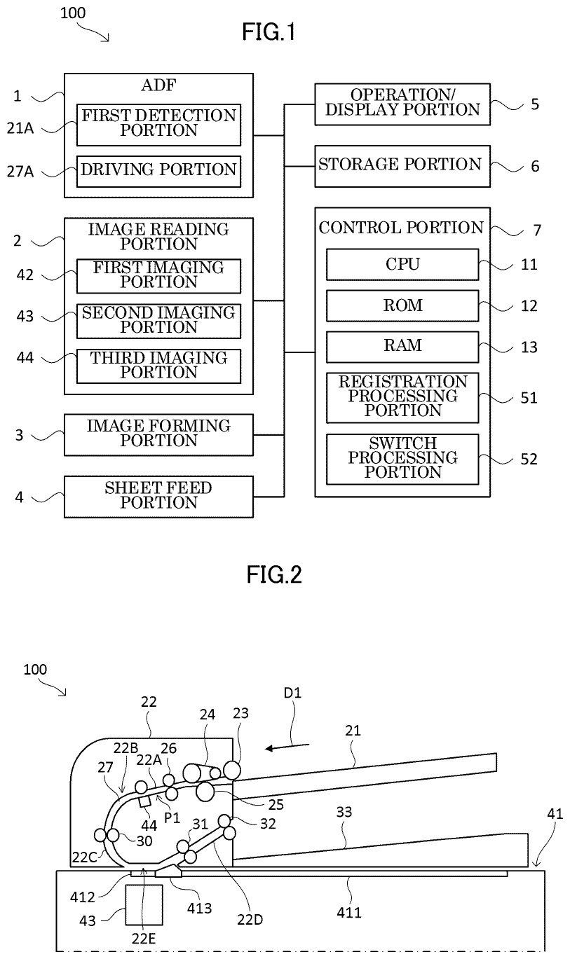

First, a configuration of an image forming apparatus 100 according to an embodiment of the present disclosure is described with reference to FIG. 1.

The image forming apparatus 100 is a multifunction peripheral having a plurality of functions such as a scan function for reading an image from a document sheet, a print function for forming an image based on image data, a facsimile function, and a copy function. The image forming apparatus 100 is an example of an image forming apparatus of the present disclosure. It is noted that the image forming apparatus of the present disclosure may be a scanner, a facsimile device, a copier, or the like.

As shown in FIG. 1, the image forming apparatus 100 includes an ADF (Auto Document Feeder) 1, an image reading portion 2, an image forming portion 3, a sheet feed portion 4, an operation/display portion 5, a storage portion 6, and a control portion 7.

The ADF 1 is a sheet conveying device for conveying a document sheet (an example of a sheet of the present disclosure) that is a reading object. The ADF 1 executes, in accordance with a control instruction from the control portion 7, a conveyance process using a driving force supplied from a driving portion 27A.

The image reading portion 2 reads an image from a document sheet conveyed by the ADF 1. In addition, the image reading portion 2 reads an image from a document sheet placed on a document sheet table 41 (see FIG. 2).

The image forming portion 3 forms an image by an electrophotographic method on a sheet supplied from the sheet feed portion 4. For example, the image forming portion 3 includes a photoconductor drum, a charging roller, a laser scanning unit, a developing device, a transfer roller, a cleaning device, a fixing device, and a sheet discharge tray.

The sheet feed portion 4 supplies a sheet to the image forming portion 3. For example, the sheet feed portion 4 includes a sheet feed cassette, a manual feed tray, a sheet conveyance path, and a plurality of conveyance rollers.

The operation/display portion 5 is a user interface of the image forming apparatus 100. For example, the operation/display portion 5 includes a display portion and an operation portion, wherein the display portion, such as a liquid crystal display, is configured to display a variety of information in response to control instructions from the control portion 7, and the operation portion, such as operation keys or a touch panel, is configured to input a variety of information to the control portion 7 in response to user operations.

The storage portion 6 is a nonvolatile storage device. For example, the storage portion 6 is a storage device such as: a nonvolatile memory such as a flash memory or an EEPROM (registered trademark); an SSD (Solid State Drive); or an HDD (Hard Disk Drive).

The control portion 7 comprehensively controls the image forming apparatus 100. As shown in FIG. 1, the control portion 7 includes a CPU 11, a ROM 12, and a RAM 13. The CPU 11 is a processor that executes various types of calculation processes. The ROM 12 is a nonvolatile storage device in which are preliminarily stored various types of information such as control programs for causing the CPU 11 to execute various processes. The RAM 13 is a volatile or nonvolatile storage device that is used as a temporary storage memory (working area) for the various types of processes executed by the CPU 11. In the control portion 7, the CPU 11 executes the various types of control programs preliminarily stored in the ROM 12. This allows the control portion 7 to comprehensively control the image forming apparatus 100.

### Configuration of ADF 1 and Image Reading Portion 2

Next, with reference to FIG. 1 and FIG. 2, a configuration of the ADF 1 and the image reading portion 2 is described. Here, FIG. 2 is a cross section diagram showing the configuration of the ADF 1 and the image reading portion 2. The ADF 1 and the image reading portion 2 are an example of an image reading device of the present disclosure.

As shown in FIG. 2, the ADF 1 includes a document sheet placement portion 21, a housing 22, a pickup roller 23, a sheet feed belt 24, a separation roller 25, a resist roller 26, a first conveyance roller 30, a second conveyance roller 31, a second discharge roller 32, and a discharge portion 33.

A document sheet that is a conveyance object is placed on the document sheet placement portion 21. In the ADF 1, the document sheet placed on the document sheet placement portion 21 is conveyed in a conveyance direction D1 shown in FIG. 2.

The document sheet placement portion 21 is provided with a first detection portion 21A shown in FIG. 1. The first detection portion 21A detects presence or absence of a document sheet on the document sheet placement portion 21. For example, the first detection portion 21A is a reflection-type optical sensor provided on a document sheet placement surface of the document sheet placement portion 21.

In addition, the document sheet placement portion 21 is provided with a lift plate (not shown). The lift plate lifts a bunch of document sheets placed on the document sheet placement portion 21 up to a position of contacting with the pickup roller 23.

The housing 22 stores rollers and the like used to convey the document sheet. As shown in FIG. 2, a first conveyance path 22A and a second conveyance path 22D for guiding the document sheet are formed inside the housing 22. The second conveyance path 22D, including a curved portion 22C (see FIG. 2) curved from the first conveyance path 22A, reaches the discharge portion 33. The curved portion 22C is curved with a curvature with which the document sheet can make a U-turn in the housing 22.

In the ADF 1, the document sheet placed on the document sheet placement portion 21 is conveyed along a conveyance route that travels the first conveyance path 22A, the curved portion 22C, and the second conveyance path 22D to reach the discharge portion 33.

As shown in FIG. 2, an opening portion 22E is provided at a bottom portion of the housing 22. The opening portion 22E exposes a part of the second conveyance path 22D to outside. At the opening portion 22E, a second imaging portion 43 (see FIG. 1 and FIG. 2) of the image reading portion 2 reads an image of the document sheet conveyed by the ADF 1.

The pickup roller 23 is provided above the document sheet placement portion 21. The pickup roller 23 contacts with a surface (an upper surface) of a document sheet at the top of the bunch of document sheets lifted by the lift plate, and conveys the document sheet in the conveyance direction D1.

The sheet feed belt 24 is provided in the first conveyance path 22A. The sheet feed belt 24 contacts with a surface of the document sheet conveyed in the conveyance direction D1 by the pickup roller 23, and conveys the document sheet toward the downstream in the conveyance direction D1.

The separation roller 25 is provided under the sheet feed belt 24 in contact with the sheet feed belt 24. The separation roller 25 separates a document sheet contacting with the sheet feed belt 24 from a document sheet thereunder among a plurality of document sheets conveyed to a position where they contact with the sheet feed belt 24.

The resist roller 26 is provided downstream of the sheet feed belt 24 in the first conveyance path 22A in the conveyance direction D1. The resist roller 26 contacts with the document sheet conveyed by the sheet feed belt 24 and conveys the document sheet toward the downstream in the conveyance direction D1.

The first conveyance roller 30 is provided at the curved portion 22C of the second conveyance path 22D. Upon contacting with a document sheet, the first conveyance roller 30 conveys the document sheet toward the downstream in the conveyance direction D1.

The opening portion 22E is formed downstream of the first conveyance roller 30 in the second conveyance path 22D in the conveyance direction D1. At the opening portion 22E, the second imaging portion 43 (see FIG. 1 and FIG. 2) of the image reading portion 2 reads an image of the document sheet passing over the opening portion 22E.

The second conveyance roller 31 is provided downstream of the opening portion 22E in the second conveyance path 22D in the conveyance direction D1. Upon contacting with the document sheet conveyed by the first conveyance roller 30, the second conveyance roller 31 conveys the document sheet toward the downstream in the conveyance direction D1.

The second discharge roller 32 is provided downstream of the second conveyance roller 31 in the second conveyance path 22D in the conveyance direction D1. Upon contacting with the document sheet conveyed by the second conveyance roller 31, the second discharge roller 32 discharges the document sheet to the discharge portion 33. The document sheet discharged by the second discharge roller 32 is stacked on the discharge portion 33.

As shown in FIG. 1 and FIG. 2, the image reading portion 2 includes the document sheet table 41, a first imaging portion 42, a second imaging portion 43, and a third imaging portion 44.

A document sheet that is a reading object is placed on the document sheet table 41. The document sheet table 41 is provided at an upper part of a housing of the image forming apparatus 100. The ADF 1 is provided in an openable and closable manner with respect to the document sheet table 41, and also serves as a document sheet cover that supports one surface of a document sheet placed on a first contact glass 411 of the document sheet table 41.

As shown in FIG. 2, the document sheet table 41 includes the first contact glass 411, a second contact glass 412, and a guide member 413. A document sheet from which an image is to be read by the second imaging portion 43 is placed on the first contact glass 411. In a state where the ADF 1 is closed to the document sheet table 41, the second contact glass 412 and the guide member 413 face the opening portion 22E of the housing 22 and form a part of the second conveyance path 22D. The second contact glass 412 transmits the light that has been emitted from the second imaging portion 43 toward the opening portion 22E, and transmits the light reflected from the document sheet. The guide member 413, at a position downstream of the second contact glass 412 in the conveyance direction D1, guides the document sheet to the second conveyance roller 31.

The second imaging portion 43 is provided below the first contact glass 411 and the second contact glass 412. The second imaging portion 43 is elongated in the depth direction of FIG. 2, and is provided movable along the left/right direction of FIG. 2. In a state of being disposed below the second contact glass 412, the second imaging portion 43 reads an image of a front surface of a document sheet conveyed by the ADF 1. Specifically, the second imaging portion 43 includes a CIS (Contact Image Sensor) and a housing storing the CIS. The second imaging portion 43 outputs an analog signal corresponding to the image read from the front surface of the document sheet. The analog signal output from the second imaging portion 43 is converted into a digital signal (image data) by an analog front-end circuit (not shown) and is input to the control portion 7.

The first imaging portion 42 is provided downstream in the first conveyance path 22A in the conveyance direction D1 and upstream of a first discharge roller 28 in the conveyance direction D1. The first imaging portion 42 reads an image of a front surface of a document sheet guided to the downstream in the first conveyance path 22A. Specifically, the first imaging portion 42 is a CIS. The first imaging portion 42 outputs an analog signal corresponding to the image read from the front surface of the document sheet. The analog signal output from the first imaging portion 42 is converted into a digital signal (image data) by the analog front-end circuit and is input to the control portion 7.

The third imaging portion 44 is provided upstream in the first conveyance path 22A in the conveyance direction D1 and downstream of the resist roller 26 in the conveyance direction D1. The third imaging portion 44 reads an image of a back surface of a document sheet conveyed by the resist roller 26. Specifically, the third imaging portion 44 is a CIS. The third imaging portion 44 outputs an analog signal corresponding to the image read from the back surface of the document sheet. The analog signal output from the third imaging portion 44 is converted into a digital signal (image data) by the analog front-end circuit and is input to the control portion 7.

The ADF 1 operates upon receiving a driving force supplied from the driving portion 27A shown in FIG. 1. The driving portion 27A is a driving portion of the present disclosure and is, for example, a motor. The driving portion 27A outputs a driving force to the ADF 1 in accordance with a control instruction from the control portion 7. In addition, the driving portion 27A is set to an ON state or an OFF state in accordance with a control instruction from the control portion 7.

Meanwhile, when the motor (the driving portion 27A) performs driving (operates) for a long time continuously, the temperature rises and it may lead to a failure. Conventionally known is a technology for predicting the temperature of the motor from the rotation amount of the motor and controls the driving of the motor based on the predicted temperature. However, according to this technology, since it is necessary to always monitor the rotation amount of the motor, processes are complicated. In particular, in an image reading device that is ideally reduced in weight and size, the processes need to be simplified. It is accordingly required that suppression of temperature rise of the motor is realized by a simpler configuration. On the other hand, in the image forming apparatus 100 according to the embodiment of the present disclosure, as described below, it is possible to suppress temperature rise of the driving portion (motor) by a simple configuration.

### Configuration of Control Portion 7

Next, a configuration of the control portion 7 is described in more detail with reference to FIG. 1. As shown in FIG. 1, the control portion 7 includes a registration processing portion 51 and a switch processing portion 52.

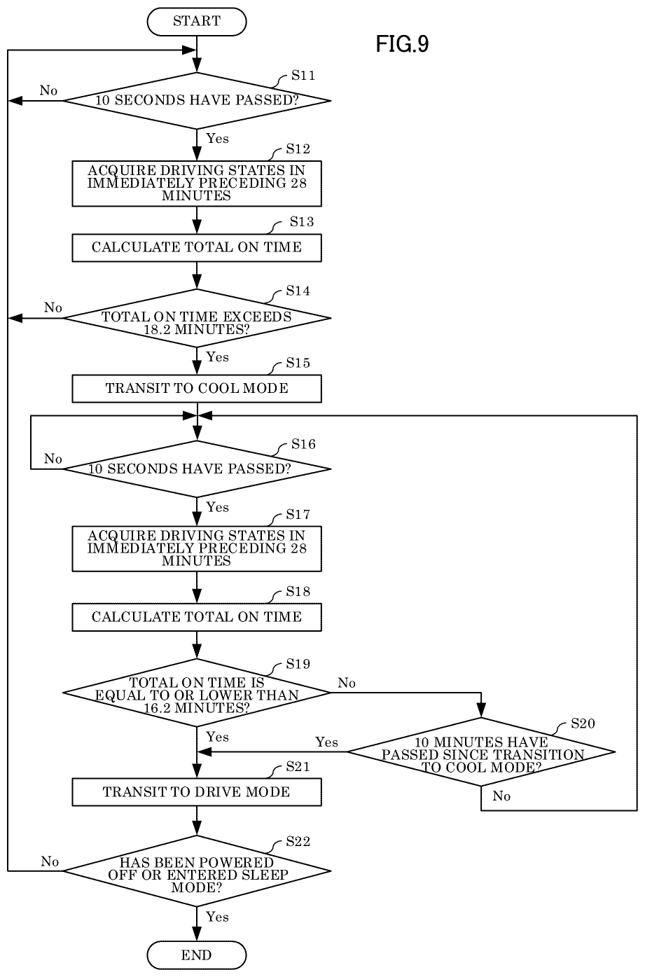

Specifically, an operation mode switching program for causing the CPU 11 to execute an operation mode switching process (see FIG. 9) described below is preliminarily stored in the ROM 12. The control portion 7 functions as the registration processing portion 51 and the switch processing portion 52 by executing the operation mode switching program stored in the ROM 12. Here, a device including the ADF 1, the image reading portion 2, and the control portion 7 is an example of the image reading device of the present disclosure. It is noted that the present disclosure may be realized by a device including the ADF 1 and the control portion 7.

It is noted that the operation mode switching program may be recorded on a non-transitory computer-readable recording medium such as a CD, a DVD, or a flash memory, and may be read from the recording medium and stored in a storage device such as the storage portion 6. In addition, the registration processing portion 51 and the switch processing portion 52 may be composed of an electronic circuit such as an integrated circuit (ASIC).

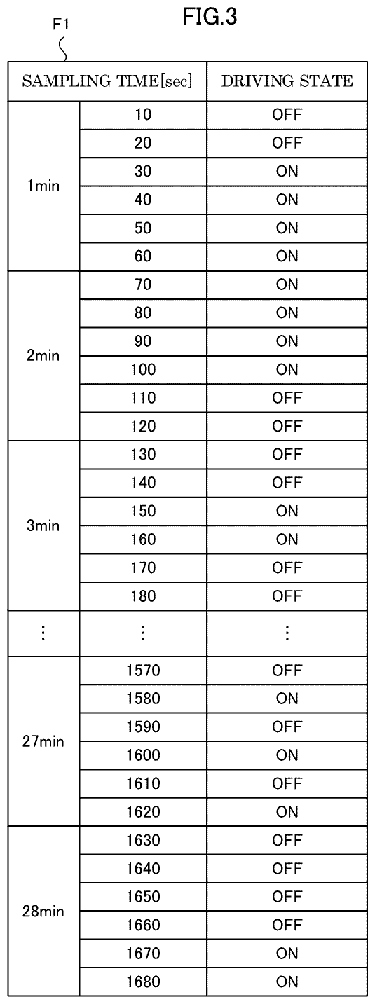

The registration processing portion 51 registers a driving state of the driving portion 27A in the storage portion 6. Specifically, the registration processing portion 51 acquires, at a predetermined cycle (a sampling time), the driving state of the driving portion 27A that is the ON state or the OFF state, and registers the driving state in driving state information F1 (see FIG. 3) stored in the storage portion 6. In the example shown in FIG. 3, the sampling time is set to 10 seconds. The registration processing portion 51 acquires the driving state of the driving portion 27A every 10 seconds, and registers the driving state in the driving state information F1. It is noted that, for example, the driving portion 27A is in the ON state while the user is performing the image reading operation and the ADF 1 is operating (conveying the sheet, and so on), and is in the OFF state while the image reading operation is not performed.

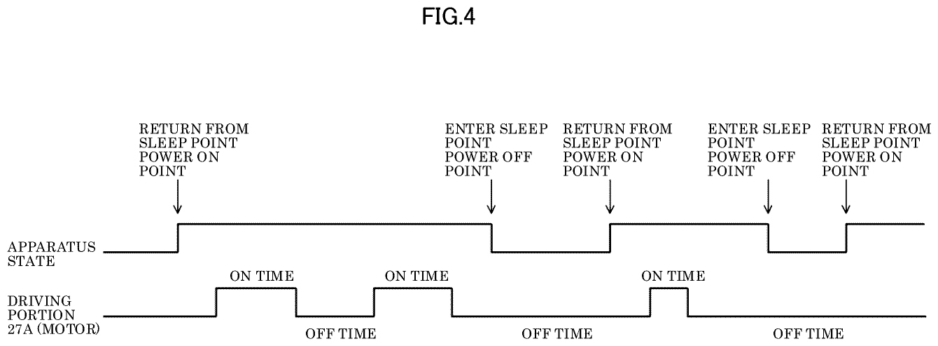

In addition, as shown in FIG. 4, the driving portion 27A is repeatedly in the ON state and the OFF state alternately while the power of the image forming apparatus 100 is in the ON state after it is powered on or after it returns from a sleep mode. The driving portion 27A is in the OFF state while the power of the image forming apparatus 100 is in the OFF state.

In addition, the registration processing portion 51 registers the following ON times and OFF times in the storage portion 6: an ON time for which the image forming apparatus 100 is in the ON state; an OFF time for which the image forming apparatus 100 is in the OFF state; an ON time for which the driving portion 27A is in the ON state; and an OFF time for which the driving portion 27A is in the OFF state. For example, the registration processing portion 51 updates the OFF time of the driving portion 27A at a timing when the power of the image forming apparatus 100 enters the ON state or at a timing when it returns from the sleep mode, and the registration processing portion 51 updates the ON time of the driving portion 27A at a timing when the power of the image forming apparatus 100 enters the OFF state or at a timing when it enters the sleep mode.

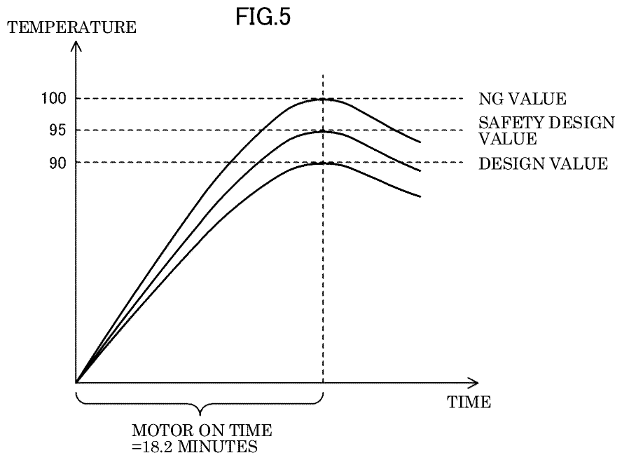

The switch processing portion 52 switches the operation mode of the driving portion 27A alternately between a drive mode (normal mode) for driving the ADF 1 and a cool mode for cooling the driving portion 27A. When the driving portion 27A performs driving continuously, the temperature rises. As a result, when a temperature rise is expected, the switch processing portion 52 switches the operation mode of the driving portion 27A to the cool mode. For example, as shown in an experimental result of FIG. 5, when the motor performs driving continuously for 18.2 minutes, the temperature of the motor rises up to 90 degrees (design value). As understood from this, it is possible to grasp the temperature of the motor from a total driving time (total ON time) of the motor in a predetermined time period that has passed from a time when the image forming apparatus 100 was powered on or from a time when it returned from the sleep mode.

Taking the above into consideration, when the total driving time of the motor in the predetermined time period exceeds a first threshold, the switch processing portion 52 switches the operation mode to the cool mode. In the cool mode, when a front edge of a new document sheet reaches a read wait position (e.g. a position in front of the opening portion 22E), the process for reading the document sheet is not executed, but it is stopped at the position for a certain time (e.g. four seconds), and after the certain time passes, the image reading portion 2 executes the image reading process. That is, when a document sheet is conveyed to the read wait position, the document sheet waits at the position until a permission is given. In this way, in the cool mode, a temporary stop period is set for each image reading in such a way as to stop the driving portion 27A temporarily (OFF state), thereby suppressing temperature rise.

As described above, the switch processing portion 52 switches the operation mode of the driving portion 27A such that in each of the drive mode and the cool mode, the driving portion 27A outputs the driving force to drive the ADF 1.

The switch processing portion 52 switches from the drive mode to the cool mode by having a configuration of, for example, a first to third practical examples shown below.

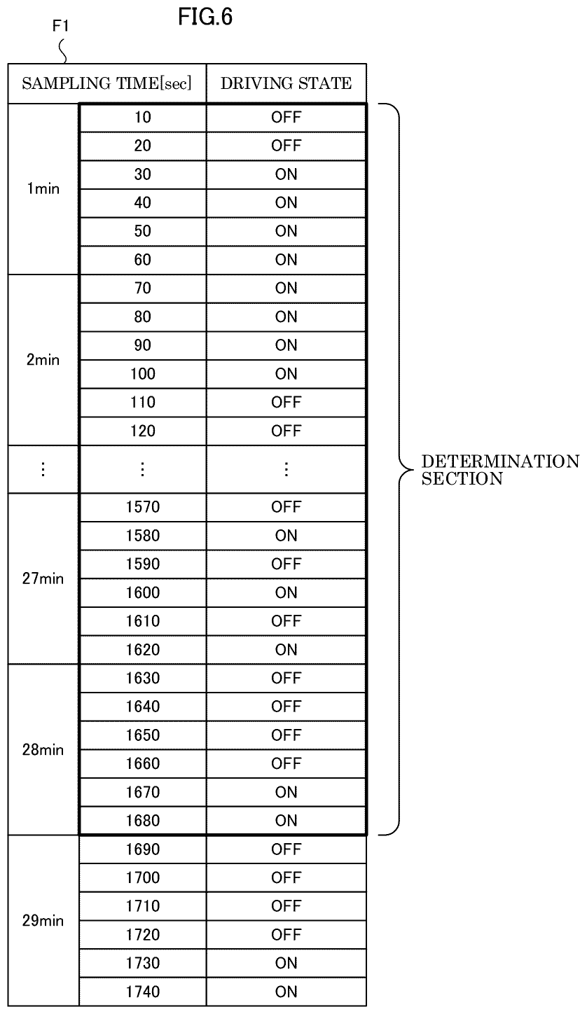

As a first practical example, the switch processing portion 52 calculates, as the total driving time, a total of times for each of which the driving portion 27A is continuously in the ON state in the initial predetermined time period (determination section) after transition to the drive mode. For example, the switch processing portion 52 consults the driving state information F1 (see FIG. 6) and calculates the total driving time by totaling times for each of which the driving state is the ON state continuously in the initial 28 minutes (determination section) after transition to the drive mode. Here, when the total driving time (continuous ON time) exceeds the first threshold (e.g. 18.2 minutes), the switch processing portion 52 switches the operation mode to the cool mode.

As a second practical example, the switch processing portion 52 calculates, as the total driving time, a total of times for each of which the driving portion 27A is in the ON state in the initial predetermined time period after transition to the drive mode. For example, the switch processing portion 52 consults the driving state information F1 (see FIG. 6) and calculates the total driving time by totaling times for each of which the driving state is the ON state in the initial 28 minutes (determination section) after transition to the drive mode. Here, when the total driving time exceeds the first threshold (e.g. 18.2 minutes), the switch processing portion 52 switches the operation mode to the cool mode.

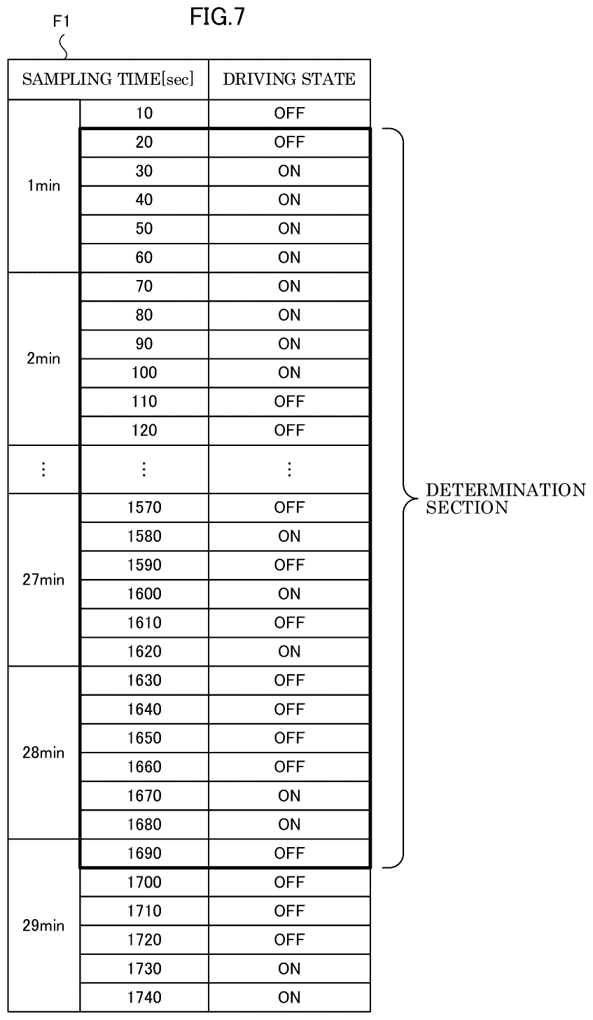

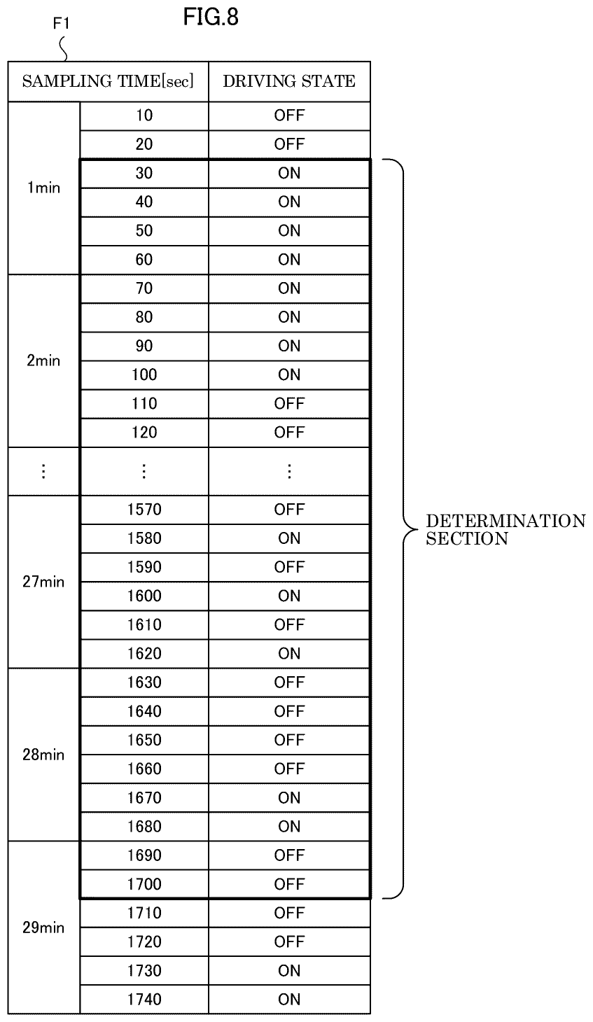

As a third practical example, the switch processing portion 52 calculates, as the total driving time, a total of times for each of which the driving portion 27A is in the ON state in the immediately preceding predetermined time period. For example, the switch processing portion 52 consults the driving state information F1 (see FIG. 6) and calculates the total driving time by totaling times for each of which the driving state is the ON state in the immediately preceding 28 minutes (determination section). Here, when the total driving time exceeds the first threshold (e.g. 18.2 minutes), the switch processing portion 52 switches the operation mode to the cool mode. When the total driving time is equal to or lower than the first threshold, the switch processing portion 52 consults the next sequence of driving state information F1 after 10 seconds (see FIG. 7) and calculates the total driving time by totaling times for each of which the driving state is the ON state in the immediately preceding 28 minutes (determination section). Here, when the total driving time exceeds the first threshold (e.g. 18.2 minutes), the switch processing portion 52 switches the operation mode to the cool mode. Similarly, when the total driving time is equal to or lower than the first threshold, the switch processing portion 52 consults the next sequence of driving state information F1 after further 10 seconds (see FIG. 8) and calculates the total driving time by totaling times for each of which the driving state is the ON state in the immediately preceding 28 minutes (determination section). Here, when the total driving time exceeds the first threshold (e.g. 18.2 minutes), the switch processing portion 52 switches the operation mode to the cool mode. It is noted that in the third practical example, the switch processing portion 52 may calculate, as the total driving time, a total of times for each of which the driving portion 27A is continuously in the ON state in the immediately preceding predetermined time period.

As described above, the ON state or the OFF state of the driving portion 27A is recorded in the storage portion 6 (driving state information F1) at the predetermined cycle, and the switch processing portion 52 calculates the total driving time by consulting the driving state information F1. In addition, when, in the drive mode, the total driving time of the driving portion 27A exceeds the first threshold, the switch processing portion 52 switches the operation mode of the driving portion 27A to the cool mode. While the total driving time of the driving portion 27A is equal to or lower than the first threshold, the switch processing portion 52 maintains the drive mode.

In addition, when, after transition to the cool mode, the total driving time of the driving portion 27A is equal to or lower than a second threshold, the switch processing portion 52 switches the operation mode to the drive mode. Specifically, when, in the cool mode, a total of times for each of which the driving portion 27A is in the ON state (total driving time) in the predetermined time period (e.g. 28 minutes) becomes equal to or lower than the second threshold (e.g. 16.2 minutes), the switch processing portion 52 switches the operation mode to the drive mode.

Even when the total driving time exceeds the second threshold (e.g. 16.2 minutes) in the cool mode, the switch processing portion 52 switches the operation mode to the drive mode when a certain time (e.g. 10 minutes) has passed since the transition to the cool mode. This is because in that case, it is expected that the temperature of the driving portion 27A has decreased sufficiently. It is noted that in this case, the switch processing portion 52 registers the total driving time as 16.2 minutes.

In the above-described configuration, the times of the first threshold and the second threshold are not limited to the above-mentioned ones, but may be appropriately set. For example, the first threshold and the second threshold may be set based on the experimental result (see FIG. 5) that varies depending on the use environment of the image forming apparatus 100.

In processes other than the above-described ones, the control portion 7 causes the image reading portion 2 to execute the image reading process and causes the image forming portion 3 to execute the image forming process. In addition, the control portion 7 displays various types of operation screens on the operation/display portion 5.

### Operation Mode Switching Process

FIG. 9 shows an example of the procedure of an operation mode switching process executed by the control portion 7 in the image forming apparatus 100.

It is noted that the present disclosure can be recognized as an operation mode switching method (the image reading method of the present disclosure) that executes one or more steps included in the operation mode switching process. In addition, one or more steps included in the operation mode switching process described here may be omitted as necessary. In addition, steps of the operation mode switching process may be executed in different orders as far as the same action effect is obtained. Furthermore, although in this description the control portion 7 executes the steps of the operation mode switching process, in other embodiments, one or more processors may execute the steps of the operation mode switching process dispersedly.

The operation mode switching process is executed when the power of the image forming apparatus 100 enters the ON state or when it returns from the sleep mode.

### Step S11

First, in step S11, the control portion 7 determines whether or not the sampling time (e.g. 10 seconds) has passed. Upon determining that the sampling time has passed (S11: Yes), the control portion 7 moves the process to step S12. The control portion 7 waits until the sampling time passes (S11: No).

Here, the control portion 7 checks the driving state of the driving portion 27A, for example, every one second, and registers the ON time or the OFF time of the driving portion 27A in the driving state information F1 (see FIG. 3) every 10 seconds.

### Step S12

In step S12, the control portion 7 acquires, from the driving state information F1 (see FIG. 3), the driving states (the ON time and the OFF time) of the driving portion 27A in the immediately preceding predetermined time period (e.g. 28 minutes).

### Step S13

In step S13, the control portion 7 calculates the total driving time (total ON time) by totaling times for each of which the driving state of the driving portion 27A is the ON state. It is noted that the control portion 7 may calculate the total driving time by totaling times for each of which the driving state of the driving portion 27A is the ON state continuously.

### Step S14

In step S14, the control portion 7 determines whether or not the calculated total ON time exceeds the first threshold (e.g. 18.2 minutes). Upon determining that the total ON time exceeds the first threshold (S14: Yes), the control portion 7 moves the process to step S15. On the other hand, upon determining that the total ON time does not exceed 18.2 minutes (S14: No), the control portion 7 returns the process to step S11.

### Step S15

In step S15, the control portion 7 switches the operation mode of the driving portion 27A to the cool mode. After the operation mode of the driving portion 27A is set to the cool mode, when, for example, the image reading instruction is received, the document sheet is stopped at the read wait position (e.g. a position in front of the opening portion 22E) for a certain time (e.g. four seconds), and after the certain time passes, the image reading portion 2 executes the image reading process. In this way, in the cool mode, the temporary stop period is set for each image reading, thereby reducing the temperature of the driving portion 27A. It is noted that after the certain time passes, the control portion 7 updates the total ON time of the driving portion 27A. Step S15 is an example of a switching step of the present disclosure.

### Step S16

In step S16, the control portion 7 determines whether or not the sampling time (e.g. 10 seconds) has passed since the transition to the cool mode. Upon determining that the sampling time has passed (S16: Yes), the control portion 7 moves the process to step S17. The control portion 7 waits until the sampling time passes (S16: No).

### Step S17

In step S17, the control portion 7 acquires, from the driving state information F1 (see FIG. 3), the driving states (the ON time and the OFF time) of the driving portion 27A in the immediately preceding predetermined time period (e.g. 28 minutes).

### Step S18

In step S18, the control portion 7 calculates the total ON time of the driving portion 27A.

### Step S19

In step S19, the control portion 7 determines whether or not the calculated total ON time is equal to or lower than the second threshold (e.g. 16.2 minutes). Upon determining that the total ON time is equal to or lower than 16.2 minutes (S19: Yes), the control portion 7 moves the process to step S21. In addition, in this case, the control portion 7 registers 16.2 minutes as the total ON time. On the other hand, upon determining that the total ON time exceeds 16.2 minutes (S19: No), the control portion 7 returns the process to step S20.

### Step S20

In step S20, the control portion 7 determines whether or not a certain time (e.g. 10 minutes) has passed since the transition to the cool mode. Upon determining that the certain time has passed (S20: Yes), the control portion 7 moves the process to step S21. That is, even when the total ON time exceeds the second threshold (e.g. 16.2 minutes) in the cool mode, the control portion 7 moves the process to step S21 when the certain time (e.g. 10 minutes) has passed since the transition to the cool mode (S20: Yes). In this case, the control portion 7 registers 16.2 minutes as the total ON time. On the other hand, upon determining that the certain time has not passed (S20: No), the control portion 7 returns the process to step S16.

### Step S21

In step S21, the control portion 7 switches the operation mode of the driving portion 27A to the drive mode. After the operation mode of the driving portion 27A is set to the drive mode, when, for example, the image reading instruction is received, the normal reading process is executed without temporarily stopping the document sheet at the read wait position. Step S21 is an example of the switching step of the present disclosure.

### Step S22

In step S22, the control portion 7 determines whether the power of the image forming apparatus 100 has entered the OFF state or it has entered the sleep mode. Upon determining that the power of the image forming apparatus 100 has entered the OFF state or that it has entered the sleep mode (S22: Yes), the control portion 7 ends the operation mode switching process. On the other hand, upon determining that the power of the image forming apparatus 100 is in the ON state or that it has not entered the sleep mode (S22: No), the control portion 7 returns the process to step S11.

In the way described above, each time the power of the image forming apparatus 100 enters the ON state or it returns from the sleep mode, the control portion 7 executes the operation mode switching process repeatedly. It is noted that the above-described operation mode switching process is presented as an example, and the contents of the process and the order thereof can be changed as necessary. For example, the control portion 7 may reset the total ON time after the total ON time determination process (S14, S19). In addition, the control portion 7 may update the total OFF time of the driving portion 27A at the power ON point and the return from sleep point shown in FIG. 4, and update the total ON time of the driving portion 27A at the power OFF point and the enter sleep point. In addition, every predetermined time period (e.g. 28 minutes), the control portion 7 may register: the time for which the power of the image forming apparatus 100 is in the ON state; the time for which the power of the driving portion 27A is in the ON state; the state of the operation mode of the driving portion 27A; and the power state of the image forming apparatus 100.

As described above, when, while the driving portion 27A (motor) is set to the drive mode, the total driving time (total ON time) of the driving portion 27A exceeds the first threshold, the image forming apparatus 100 switches the operation mode of the driving portion 27A to the cool mode. For example, when, in the drive mode, the total driving time in 28 minutes (determination section) exceeds the first threshold (e.g. 18.2 minutes), the control portion 7 switches the operation mode of the driving portion 27A to the cool mode. In this way, when the ON state of the driving portion 27A reaches a predetermined time, the operation mode is switched to the cool mode, thereby suppressing temperature rise of the driving portion 27A. With the above-described configuration, it is possible to suppress temperature rise of the driving portion 27A without using a cooling fan, a temperature sensor or the like and to protect the driving portion 27A from the overheated state. It is therefore possible to suppress temperature rise of the driving portion 27A with a simple configuration. In addition, this makes it possible to reduce the cost of the image forming apparatus 100.

In addition, the control portion 7 has a configuration of switching the operation mode of the driving portion 27A to the drive mode when, after transition to the cool mode, the total driving time of the driving portion 27A is lower than the second threshold. This allows the driving portion 27A to return to the normal driving mode quickly as soon as the temperature of the driving portion 27A is decreased, thereby preventing the efficiency of the image reading process from being reduced.

### APPENDED NOTES ON THE DISCLOSURE

The following notes are appended concerning a summary of the disclosure extracted from the above-described embodiment. It is noted that the configurations and processing functions explained in the following notes can be arbitrarily selected and combined.

### Note 1

An image reading device comprising:
a conveying portion configured to convey a sheet;
a reading portion configured to read an image of the sheet;
a driving portion configured to drive the conveying portion; and
a switch processing portion configured to switch an operation mode of the driving portion alternately between a drive mode for driving the conveying portion and a cool mode for cooling the driving portion, wherein
when, in the drive mode, a total driving time of the driving portion exceeds a first threshold, the switch processing portion switches the operation mode to the cool mode.

### Note 2

The image reading device according to Note 1, wherein
when, after transition to the cool mode, the total driving time of the driving portion is lower than a second threshold, the switch processing portion switches the operation mode to the drive mode.

### Note 3

The image reading device according to Note 1 or 2, wherein
the switch processing portion calculates, as the total driving time, a total of times for each of which the driving portion is continuously in an ON state in a predetermined time period in the drive mode.

### Note 4

The image reading device according to Note 1 or 2, wherein
the switch processing portion calculates, as the total driving time, a total of times for each of which the driving portion is in an ON state in a predetermined time period in the drive mode.

### Note 5

The image reading device according to Note 1 or 2, wherein
the switch processing portion calculates, as the total driving time, a total of times for each of which the driving portion is in an ON state in an immediately preceding predetermined time period in the drive mode.

### Note 6

The image reading device according to any one of Notes 1 to 5, wherein in the cool mode, the sheet is temporarily stopped before the reading portion reads an image.

### Note 7

The image reading device according to any one of Notes 1 to 6, wherein
an ON state or an OFF state of the driving portion is recorded in a storage portion at a predetermined cycle, and
the switch processing portion calculates the total driving time by consulting the storage portion.

### Note 8

An image forming apparatus comprising:
the image reading device according to any one of Notes 1 to 7; and
an image forming portion configured to form an image on the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading device comprising:
a conveying portion configured to convey a sheet;
a reading portion configured to read an image of the sheet;
a driving portion configured to drive the conveying portion; and
a switch processing portion configured to switch an operation mode of the driving portion alternately between a drive mode for driving the conveying portion and a cool mode for cooling the driving portion, wherein
when, in the drive mode, a total driving time of the driving portion exceeds a first threshold, the switch processing portion switches the operation mode to the cool mode.

2. The image reading device according to claim 1, wherein
when, after transition to the cool mode, the total driving time of the driving portion is lower than a second threshold, the switch processing portion switches the operation mode to the drive mode.

3. The image reading device according to claim 1, wherein
the switch processing portion calculates, as the total driving time, a total of times for each of which the driving portion is continuously in an ON state in a predetermined time period in the drive mode.

4. The image reading device according to claim 1, wherein
the switch processing portion calculates, as the total driving time, a total of times for each of which the driving portion is in an ON state in a predetermined time period in the drive mode.

5. The image reading device according to claim 1, wherein
the switch processing portion calculates, as the total driving time, a total of times for each of which the driving portion is in an ON state in an immediately preceding predetermined time period in the drive mode.

6. The image reading device according to claim 1, wherein in the cool mode, the sheet is temporarily stopped before the reading portion reads an image.

7. The image reading device according to claim 1, wherein
an ON state or an OFF state of the driving portion is recorded in a storage portion at a predetermined cycle, and
the switch processing portion calculates the total driving time by consulting the storage portion.

8. An image forming apparatus comprising:
the image reading device according to claim 1; and
an image forming portion configured to form an image on the sheet.

9. An image reading method comprising
a switching step of, in an image reading device including: a conveying portion configured to convey a sheet; a reading portion configured to read an image of the sheet; and a driving portion configured to drive the conveying portion, switching an operation mode of the driving portion alternately between a drive mode for driving the conveying portion and a cool mode for cooling the driving portion, wherein
in the switching step, when, in the drive mode, a total driving time of the driving portion exceeds a first threshold, the operation mode is switched to the cool mode.
